(19) United States
(12) Patent Application Publication
(10) Pub. No.: US 2009/0049995 A1
(43) Pub. Date: Feb. 26, 2009

(54) Folding rack

(76) Inventors: John K. St. Laurent, Tiverton, RI (US); David A. Ferreira, Tiverton, RI (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/892,510

(22) Filed: Aug. 23, 2007

(51) Int. Cl. A47J 37/04

(52) U.S. Cl. 99/419

(57) ABSTRACT

The folding rack includes a planar grill having folding tine rows extending therefrom. At least some rows include stops extending thereacross to prevent the rows from passing substantially beyond the vertical when they are extended from their stored positions adjacent to the grill. At least one tine row may be free of such a stop, allowing that row to pivot from one side of its pivot axis to the other. The tips of the tines are exposed to allow food or other articles to be placed between or impaled upon the tines. The grill may optionally be equipped with folding legs. The rack is preferably formed of suitable food and temperature safe material, e.g., stainless steel, for use in cooking. The various components of the rack may be coated with a non-stick coating to facilitate cleanup.

### BACKGROUND OF THE INVENTION

1. Field of the Invention

The present invention relates generally to cooking utensils, supports, racks, brackets, and the like. More particularly, the present invention relates to a folding rack that supports poultry, including supports for multiple poultry wings.

2. Description of the Related Art

Innumerable grills, racks, and the like have been developed in the past for holding food while cooking. Most such racks are relatively simple devices, and are not optimized for efficient use or storage. For example, pieces of food must be laid out flat upon an ordinary flat grill. This results in each piece taking up considerably more horizontal room or space than would be required if some means were available to hold the piece upright or on edge. A grill having such means for holding pieces of food upright while cooking would enable the cook to prepare more food on a given size grill, oven, barbecue, or the like. The articles of food are also generally more evenly exposed to the cooking heat, thus providing more even cooking of the food.

Thus, a folding rack solving the aforementioned problems is desired.

### SUMMARY OF THE INVENTION

The folding rack includes a relatively flat, horizontal grill component having a series of rows of tines foldably extending therefrom. The tip of each tine is exposed. Adjacent tines define an open capture area therebetween, allowing food or other items to be placed between, or impaled upon, the tines. At least some of the tine rows are configured with stop bars to limit angular motion of the hinged tines and prevent the tines from passing substantially beyond the vertical, relative to the plane of the grill. Another tine row may be provided without such limit, to allow that row to be pivoted or hinged through 180° of travel. The grill or rack may include a series of folding legs, which may operate in the same manner as the folding tines. All of the tines in any given row and the legs at each end of the grill are interconnected to fold and extend together.

As the device is primarily oriented for use in cooking, it is preferably constructed of a material that is safe for use in cooking and coming into contact with food, e.g., stainless steel wire or rod. The material may be coated with a non-stick coating that is safe for food contact, e.g., Teflon® (polytetrafluoroethylene resin; Teflon is a registered trademark of E.I. du Pont de Nemours and Company of Wilmington, Del.).

These and other features of the present invention will become readily apparent upon further review of the following specification and drawings.

### BRIEF DESCRIPTION OF THE DRAWINGS

FIG. 1 is an environmental, perspective view of a folding rack according to the present invention, showing its placement in a roasting pan for cooking.

FIG. 2 is a side elevation view of a folding rack according to the present invention, showing the folding of the various rows of tine racks of the device.

FIG. 3 is a detailed, partial perspective view of one corner of a folding rack according to the present invention, showing hinge and stop details for one of the tine racks and optional support leg elements.

FIG. 4A is a detailed, partial perspective view of a portion of a folding rack according to the present invention, showing a first tine rack configuration having blunt tine ends, one of the tines being broken away to show an optional coating shown disposed partially thereover.

FIG. 4B is a detailed, partial perspective view of a portion of a folding rack according to the present invention, showing a second tine rack configuration having sharpened or pointed tine ends.

FIG. 4C is a detailed, partial perspective view of a portion of a folding rack according to the present invention, showing a third tine rack configuration having bladed tine ends.

Similar reference characters denote corresponding features consistently throughout the attached drawings.

### DETAILED DESCRIPTION OF THE PREFERRED EMBODIMENTS

The present invention relates to various embodiments of a folding rack for use in cooking articles of food. The folding rack includes a series of tine rows, which may be folded downwardly adjacent the plane of the grill when not in use or extended to support articles atop the grill. Folding support legs may optionally be provided as well.

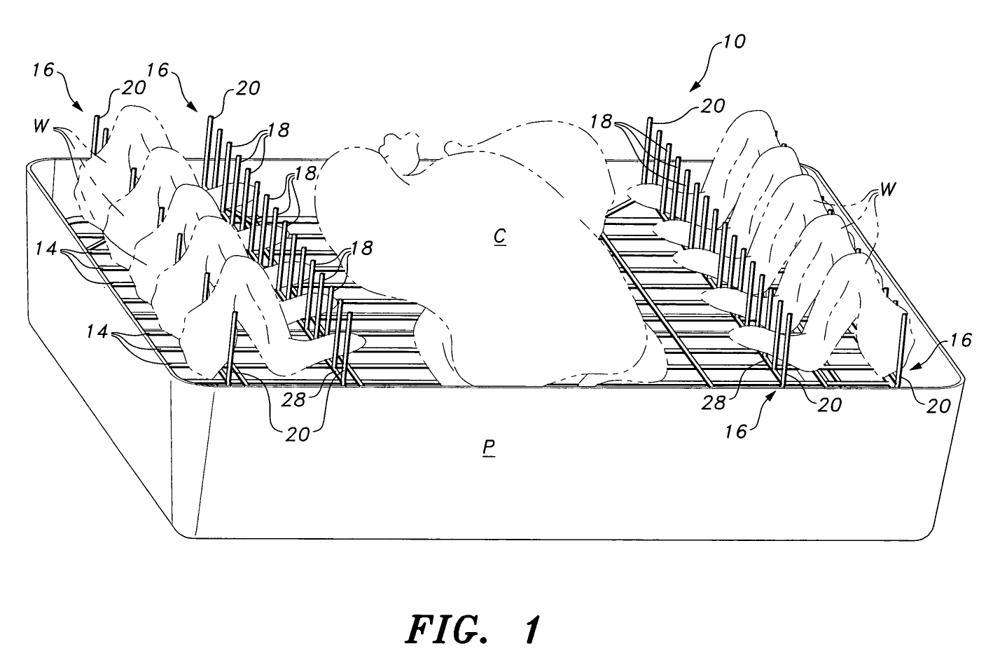

FIG. 1 of the drawings provides an environmental perspective view of a first embodiment of a folding rack 10, shown resting upon or in a pan P and holding several food articles (e.g., chicken wings W and a chicken C) for cooking. The folding rack 10 has a flat, planar grill portion 12 formed of a series of substantially parallel grill elements 14 (e.g., steel wire or rod, etc.). At least one, and preferably several, tine row(s) 16 extend foldably from the grill portion 12. Each tine row 16 has multiple individual tines 18 extending therefrom. Each tine row extends and folds as a unit. FIG. 1 shows two pairs of parallel tine rows 16, the two rows 16 in each pair being spaced apart and the tines 18 in each of the rows 16 being uniformly spaced apart in order to facilitate the placement of wings W or other food articles extending between the rows 16 in each pair and supported between or upon adjacent tines 18.

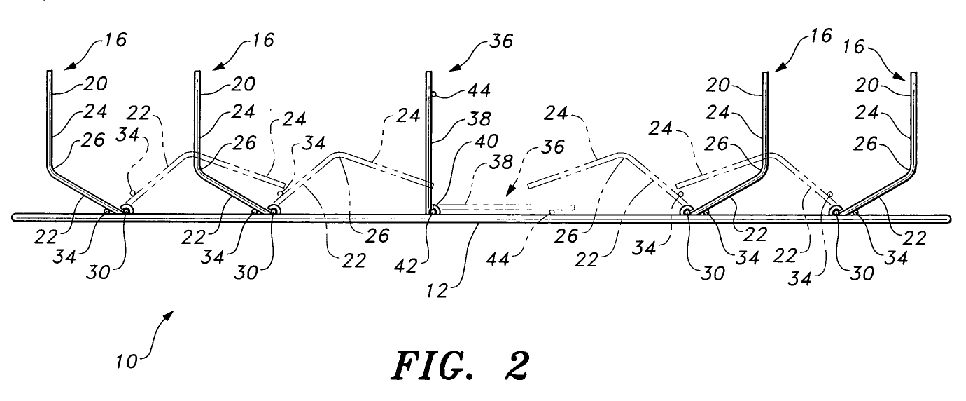

FIG. 2 is a front elevation view of the folding rack 10, showing the configurations of the grill attachment arms 20 at the opposite ends of each of the tine rows 16 and pivotal attachment of the arms 20 to the grill 12. Each grill attachment arm 20 has a proximal grill extension portion 22 and an opposite, distal tine portion 24. The two portions 22 and 24 have a bend 26 formed generally medially therebetween, with the bend 26 being greater than ninety degrees, most preferably about 120°, the two arm portions 22 and 24 defining an obtuse angle therebetween.

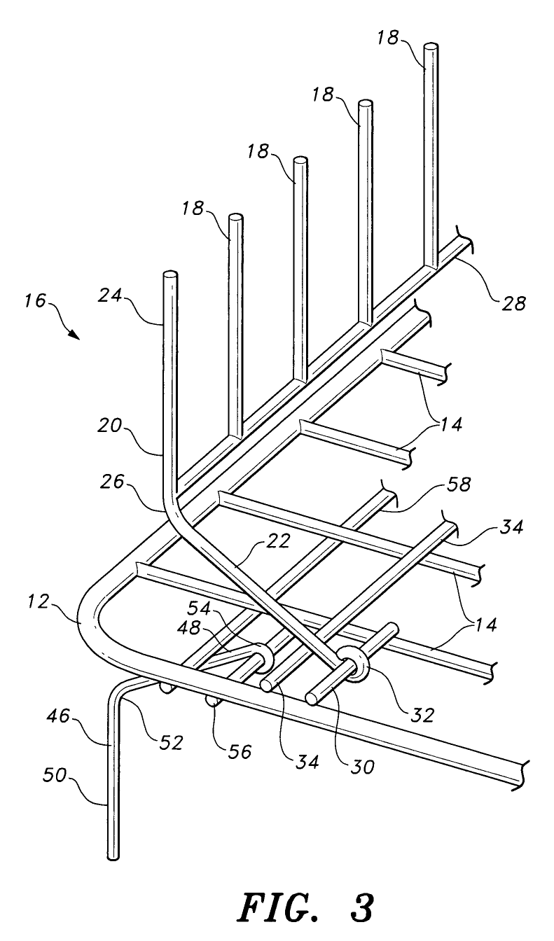

A tine support element 28, shown most clearly in FIG. 3, extends laterally between or across the corresponding opposed grill attachment arms 20 of each tine row 16, with the tines 18 extending distally from support element 28. Thus, only the two grill attachment arms 20 of each tine row 16 attach directly to the grill 12, with the individual tines 18 extending from the tine support element 28, which, in turn, extends laterally across the corresponding two grill attachment arms 20 of each tine row 16.

Each of the tine rows 16 is pivotally secured to the grill portion 12 to allow folding of the tine rows 16 when not needed. The general folding operation is illustrated in FIG. 2 of the drawings, with FIG. 3 providing a detailed view of pivotal attachment of one tine row 16 to the grill 12, as well as the extension and retraction stops provided for the tine rows 16. A tine row attachment pintle (or pintles) 30 extends across at least a pair of grill elements 14 substantially normal thereto. The pintle(s) 30 may comprise a single wire or short rod that extends completely across the entire width of the grill 12, or two shorter lengths extending across the outermost grill frame peripheral member and adjacent grill element 14, as shown in FIG. 3.

The grill extension portion 22 of each of the two opposite grill attachment arms 20 includes a tine row pintle attachment loop 32 formed about the corresponding pintle 30. Thus, the two grill attachment arms 20 hinge or pivot about their respective attachment pintles 30. As the two grill attachment arms 20 are rigidly secured together by the lateral tine support element 28, the two attachment arms 20, tine support element 28, and tines 18 extending therefrom all hinge or pivot together as a unit for each tine row 16.

Pivoting of the tines 18 (and the tine portions 24 of their associated grill attachment arms 20) is limited to an extended position substantially normal to the plane of the grill 12 by a tine row extension stop 34 attached to the grill extension portions 22 of the two opposite grill attachment arms 20 of each tine row 16. These tine row extension stops 34 contact the grill elements 14 and/or peripheral frame member of the grill 12 when the tines 18 are fully extended, thus stopping the tines in an orientation substantially normal to the plane of the grill 12.

The tine rows 16 are further limited in their retraction through the plane of the grill by one or more tine row retraction stops, which extend across two or more of the parallel grill elements 14. Depending upon the spacing of the tine rows 16 from one another, these tine row retraction stops may be the same components as the tine row attachment pintles 30. It will be seen in FIG. 2 that the span of the grill attachment arms 20 of each tine row 16 is slightly greater than the spacing between the tine row attachment pintles 30 for adjacent tine rows. Thus, the ends of the grill attachment arms 20 will contact the adjacent attachment pintles 30, and prevent the tine rows 16 from dropping through the plane of the grill 12. Alternatively, separate retraction stops could be provided across adjacent grill elements 14.

The folding rack of FIGS. 1 and 2 also has an additional central folding tine row 36, shown erected in solid lines and folded in broken lines in FIG. 2. The central tine row 36 includes opposite first and second attachment arms 38, with a row of tines extending therebetween. The proximal ends of the central tine row attachment arms 38 include pintle attachment loops 40, which wrap about a corresponding central tine row attachment pintle(s) 42. The difference between the central tine row 36 and the other tine rows 16 is that the central tine row attachment arms 38 are straight or linear from their proximal end to their distal end in order to allow the central tine row 36 to fold completely flat against the surface or plane of the grill 12. In this manner, none of the components of the central tine row 36 protrude from the plane of the grill 12 to any significant extent when folded against the grill 12. This allows a larger article of food, e.g., a chicken C as shown in FIG. 1, to be placed directly atop the grill 12. The central tine row 36 may be prevented from passing through the plane of the grill by a central tine row retraction stop or stops 44 extending across the central tine row, which may serve as the retraction stop(s) for the adjacent tine row 16 when the central tine row 36 is retracted adjacent to the grill 12.

The folding rack 10 may optionally be provided with folding legs 46, as shown in FIG. 3 of the drawings. The legs 46 are preferably configured similar to the grill attachment arms 20 of the tine rows 16, i.e., having a proximal grill extension leg portion 48 and a distal leg portion 50 with a leg bend 52 defining an obtuse angle therebetween. The attachment end of the grill extension leg portion 48 includes a leg attachment loop 54 formed therein, which secures about a leg attachment pintle or pintles 56 disposed across adjacent grill elements 14 and/or the peripheral frame member of the grill 12.

A leg extension stop 58 is attached to each leg forming the support leg assembly pair at each end of the rack 10. The leg extension stop 58 serves two functions: (1) connecting the two corresponding legs 46 at each end of the grill 12 so they extend and retract as a unit; and (2) contacting the grill elements 14 when the legs 46 are fully extended (as shown in FIG. 3) to position the distal leg end portions 50 at least generally normal to the plane of the grill 12. The legs 46 may be prevented from retracting through the plane of the grill when folded by the attachment pintle 30 of the adjacent tine row 16, or by a separate stop, e.g., similar to the central tine row stop 44 shown in FIG. 2.

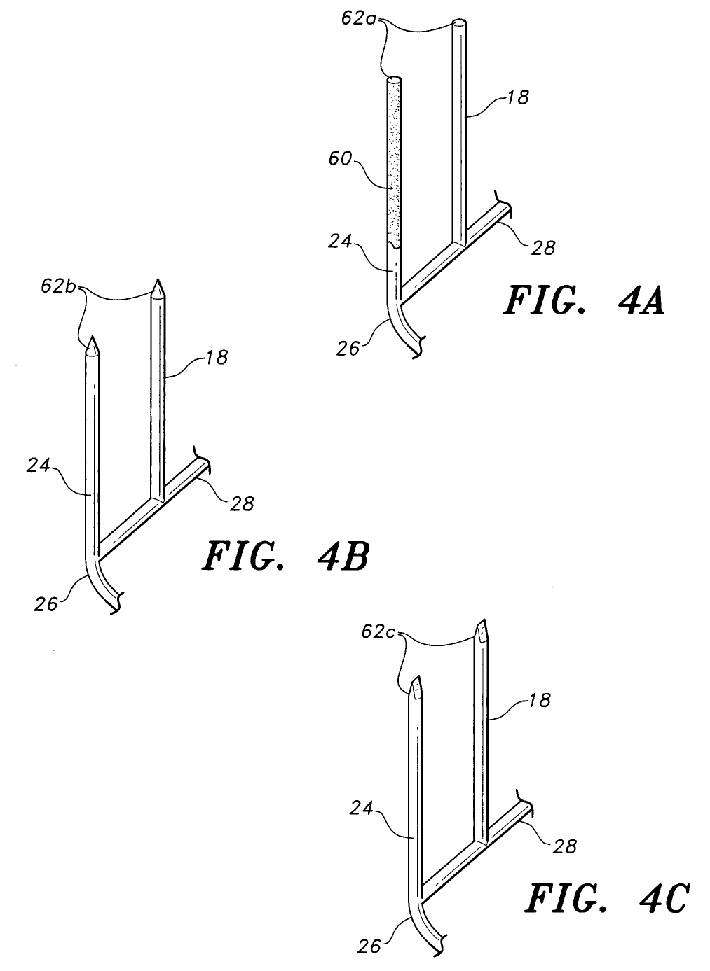

FIGS. 4A through 4C illustrate various modifications or embodiments of the folding rack 12. FIG. 4A provides a detail, partial perspective view of an exemplary tine row end portion showing the distal tine portion 24 of one grill attachment arm, one tine 18, and a portion of the corresponding tine support element 28. In FIG. 4A, the distal tine portion 24 is broken away to show its end coated with a non-stick coating 60, e.g., Teflon® or other suitable coating material, permanently applied thereto. Such non-stick coating may optionally be provided over the entire wire rack 10. Alternatively, the rack 12 may be provided in bare metal, preferably a corrosion-resistant steel, or may be plated with a suitable metal (e.g., chrome, etc.).

It will also be noted that the tips 62a of the distal tine portion 24 and tine 18 are flattened in the embodiment of FIG. 4A, as well as in the embodiments of FIGS. 1 through 3. Such blunt or flattened ends or tips may be suitable for use when materials are not to be impaled upon the tines 18, but rather placed upon them or wedged between them, as shown in FIG. 1. However, it may be desirable in some circumstances to sharpen the tines 18 to permit materials (e.g., food to be cooked, etc.) to be impaled upon the tines 18. Accordingly, FIG. 4B illustrates a distal tine portion 24 and tine 18 having conically pointed ends or tips 62b, while FIG. 4C illustrates a distal tine portion 24 and tine 18 having bladed ends or tips 62c. The exact shape or configuration of the tips is not critical to the folding rack 10, except that it is preferable that the tips be sharpened in some manner if they are to be used to impale food or other articles thereon.

In conclusion, the folding rack 10 in its various embodiments is well suited for use in cooking or grilling innumerable types of food, due to its configuration for holding the food more upright than a conventional grill. This allows more articles of food to be placed upon the rack during cooking, thereby making the cooking operation more efficient and reducing the number of batches of food which must be prepared and the number of grill or oven cycles needed.

It is to be understood that the present invention is not limited to the embodiments described above, but encompasses any and all embodiments within the scope of the following claims.

We claim:

1. A folding rack, comprising:
a flat, planar grill; and
at least one tine row pivotally attached to the grill and selectively extending therefrom, the tine row having a plurality of tines.

2. The folding rack according to claim 1, wherein the grill further comprises a plurality of mutually parallel grill elements, the folding rack further comprising:
a tine row retraction stop disposed across at least two mutually adjacent grill elements, the tine row retraction stop precluding passage of the tines substantially through the plane of the grill; and
a tine row extension stop extending across the at least one tine row, the tine row extension stop contacting the grill elements and precluding passage of the tines beyond a substantially normal orientation relative to the grill when the at least one tine row is fully extended.

3. The folding rack according to claim 1, wherein the at least one tine row has:
first and second grill attachment arms, each of the grill attachment arms having a proximal grill extension portion, a distal tine portion opposite the grill extension portion, and a generally medial bend disposed therebetween, the grill extension portion and tine portion defining an obtuse angle therebetween;
a tine support element extending laterally between the first and second grill attachment arms; and
a plurality of tines extending from the tine support element.

4. The folding rack according to claim 1, wherein the at least one tine row has first and second grill attachment arms, each of the grill attachment arms having a grill extension portion, the folding rack further comprising at least one tine row attachment pintle extending across the grill elements normal thereto, the grill extension portion of each of the grill attachment arms having a tine row pintle attachment loop disposed about the corresponding tine row attachment pintle in order to pivot the grill attachment arm about the pintle.

5. The folding rack according to claim 1, further including:
first and a second mutually opposed support leg attachment pintles extending across the grill elements normal thereto; and
mutually opposed first and second support leg assemblies, each of the support leg assemblies having a support leg forming a support leg pintle attachment loop pivotally disposed about the corresponding support leg attachment pintle.

6. The folding rack according to claim 1, wherein said grill and said tine row further include a non-stick coating permanently disposed thereon.

7. The folding rack according to claim 1, wherein each of the tines has a distal tip configuration selected from the group consisting of blunt ends, pointed ends, and bladed ends.

8. A folding rack, comprising:
a flat, planar grill having a plurality of mutually parallel grill elements;
at least one tine row extending from the grill, the tine row having a plurality of tines;
first and second mutually opposed support leg attachment pintles extending across the grill elements normal thereto;
mutually opposed first and second support leg assemblies, each of the support leg assemblies having a support leg forming a support leg pintle attachment loop pivotally disposed about the corresponding support leg attachment pintle; and
a stop extending between the first and second support leg assemblies in order to prevent the support legs from pivoting between the grill elements.

9. The folding rack according to claim 8, wherein the at least one tine row has first and second grill attachment arms, each of the grill attachment arms having a grill extension portion, the folding rack further comprising at least one tine row attachment pintle extending across the grill elements normal thereto, the grill extension portion of each of the grill attachment arms having a tine row pintle attachment loop disposed about the corresponding tine row attachment pintle in order to pivot the grill attachment arm about the pintle.

10. The folding rack according to claim 9, further comprising:
a tine row retraction stop disposed across at least two mutually adjacent grill elements, the tine row retraction stop precluding passage of the tines substantially through the plane of the grill; and
a tine row extension stop extending across the at least one tine row, the tine row extension stop contacting the grill elements and precluding passage of the tines beyond a substantially normal orientation relative to the grill when the at least one tine row is fully extended.

11. The folding rack according to claim 8, wherein the at least one tine row has:
first and second grill attachment arms, each of the grill attachment arms having a proximal grill extension portion, a distal tine portion opposite the grill extension portion, and a generally medial bend disposed therebetween, the grill extension portion and tine portion defining an obtuse angle therebetween;
a tine support element extending laterally between the first and second grill attachment arms; and
a plurality of tines extending from the tine support element.

12. The folding rack according to claim 8, wherein said grill and said tine row further include a non-stick coating permanently disposed thereon.

13. The folding rack according to claim 8, wherein each of the tines has a distal tip configuration selected from the group consisting of blunt ends, pointed ends, and bladed ends.

14. A folding rack, comprising:
a flat, planar grill having an upper side, a lower side opposite the upper side, and a plurality of mutually parallel grill elements;
at least one tine row extending from the upper side of the grill, the tine row having a plurality of tines; and
mutually opposed first and second support leg assemblies extending from the lower side of the grill.

15. The folding rack according to claim 14, wherein the at least one tine row has first and second grill attachment arms, each of the grill attachment arms having a grill extension portion, the folding rack further comprising at least one tine row attachment pintle extending across the grill elements normal thereto, the grill extension portion of each of the grill attachment arms having a tine row pintle attachment loop disposed about the corresponding tine row attachment pintle in order to pivot the grill attachment arm about the pintle.

16. The folding rack according to claim 15, further comprising:
a tine row retraction stop disposed across at least two mutually adjacent grill elements, the tine row retraction stop precluding passage of the tines substantially through the plane of the grill; and
a tine row extension stop extending across the at least one tine row, the tine row extension stop contacting the grill elements and precluding passage of the tines beyond a substantially normal orientation relative to the grill when the at least one tine row is fully extended.

17. The folding rack according to claim 14, wherein the at least one tine row has:
first and second grill attachment arms, each of the grill attachment arms having a proximal grill extension portion, a distal tine portion opposite the grill extension portion, and a generally medial bend disposed therebetween, the grill extension portion and tine portion defining an obtuse angle therebetween;
a tine support element extending laterally between the first and second grill attachment arms; and
a plurality of tines extending from the tine support element.

18. The folding rack according to claim 14, further including:
first and a second mutually opposed support leg attachment pintles extending across the grill elements normal thereto; and
mutually opposed first and second support leg assemblies, each of the support leg assemblies having a support leg forming a support leg pintle attachment loop pivotally disposed about the corresponding support leg attachment pintle.

19. The folding rack according to claim 14, wherein said grill and said tine row further include a non-stick coating permanently disposed thereon.

20. The folding rack according to claim 14, wherein each of the tines has a distal tip configuration selected from the group consisting of blunt ends, pointed ends, and bladed ends.
